(19) United States
(12) Patent Application Publication
(10) Pub. No.: US 2010/0031682 A1
(43) Pub. Date: Feb. 11, 2010

(54) SOLAR AIR CONDITIONER FOR VEHICLE

(76) Inventor: Vir S. Gaerlan, Roseville, CA (US)

Correspondence Address: ITALIA IP, 3500 WEST OLIVE AVE., SUITE 300, BURBANK, CA, 91505, US

(21) Appl. No.: 12/325,415

(22) Filed: Dec. 1, 2008

Related U.S. Application Data
(60) Provisional application No. 61/087,568, filed on Aug. 8, 2008.

(51) Int. Cl. B60H 1/32; F25B 27/00; F25B 1/00

(52) U.S. Cl. 62/228.1; 62/236; 62/115

(57) ABSTRACT

A motor vehicle having a solar air conditioning system which is entirely independent of the vehicle propulsion system. The vehicle comprises a body, at least two axles, a propulsive power plant, and a first electrical system serving the power plant, lighting, and other support functions of the motor vehicle. The air conditioning system has a refrigerant compressor including an electric motor, and a second electrical system comprising a battery, a photovoltaic element which charges the battery of the air conditioning system, and an on-off switch controlling the motor of the refrigerant compressor. The first electrical system is electrically unconnected to the second electrical system of the motor vehicle. The battery of the solar air conditioning system may be located proximate one axle and the refrigerant compressor may be located proximate the other axle.

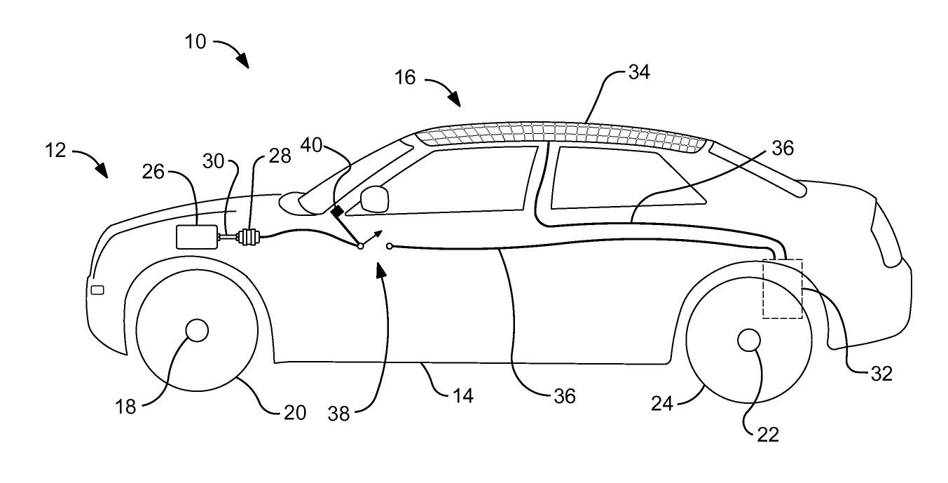

### CROSS-REFERENCE TO RELATED APPLICATION

This Non-Provisional Application claims the benefit of the filing date under 35 USC 119(e) of the filing date of U.S. Provisional Application Ser. No. 61/087,568, filed Aug. 8, 2008.

### FIELD OF THE INVENTION

The present invention relates to vehicular air conditioning systems, and more particularly to a solar powered air conditioning system which is a complete, stand-alone system independent of a motor driven power plant.

### BACKGROUND OF THE INVENTION

Most commercially available motor vehicles for sale to the general public today are equipped with air conditioning. Typically, the air conditioning system uses an engine driven compressor which is selectively coupled to and uncoupled from the engine by an electromagnetic clutch. Electric vehicles may have compressors powered by electric motors. There have also been developed hybrid systems wherein the compressor is actually two compressors in one, with one power input derived by clutching to the engine in conventional fashion and the other power input provided by an electric motor. In certain limited aspects of cooling in a vehicle, such as cooling of the steering wheel, an electrothermal device such as a Peltier effect cooler may be used.

In all of the above cases, using the air conditioning system imposes an additional load on the engine or the battery. This is objectionable as it increases fuel or energy consumption, may limit the range of travel of the vehicle, and may reduce available power of the power plant.

Further, there is often the need to keep the interior of a vehicle from reaching extreme temperatures, as can be the case when a car is parked on a sunny day. Such a need can derive from having perishable items located in the interior or for safety reasons when an individual is left in the vehicle. There exists a need for an efficiently powered air conditioning system for a motor vehicle.

### SUMMARY OF THE INVENTION

The present invention meets the above stated need by providing a solar powered air conditioner. Power is supplied by photovoltaic elements disposed on the exterior of the vehicle body. Power for the air conditioning system is therefore characterized by all benefits of solar energy, such as the power being free, renewable, domestically produced, devoid of pollution, and generating minimal waste heat. Generation of waste heat is minimized in that when the principal power plant of a vehicle is an internal combustion engine, the waste heat is limited to that of the electric motor, as opposed to internal combustion engine losses which even with relatively efficient diesel engines, are typically three times as great. Thus objectionable waste heat imposed on the engine compartment is slightly reduced.

Power derived from a photovoltaic source may be stored in a battery which is dedicated only to the air conditioning system. This characteristic enables energy to be stored, so that, for example, when the vehicle is parked in the sun and is not in use, power for future use by the air conditioning system may be accumulated.

Any type of refrigerant compressor may be used, and may be powered by an electric motor which is independent of the power plant used for propulsion of the vehicle. The clutch used in conventionally powered compressors and related apparatus are thereby eliminated.

The novel arrangement reduces several loads which are normally imposed on the propulsive power plant. Obviously, the load of the compressor is removed from the propulsive power plant. In addition, power absorbed by conventional air conditioning clutches is eliminated, as are minor power losses associated with drive belts. It may be possible in some cases to eliminate one drive belt, wherein the compressor has a dedicated belt. Even where one belt is used to drive plural auxiliary devices, such as an alternator, a power steering pump, a coolant pump, and possibly others, that belt may be relieved of the burden associated with air conditioning. The belt may be slightly smaller, will take up less room in what is usually a crowded engine bay, and will experience slightly less loss due to flexure.

Because the solar air conditioning system is independent of the propulsive power plant, the compressor, motor, and dedicated battery may be located at the discretion of the designers of the vehicle. This may be exploited, for example, by locating the compressor, its motor, and the battery low on the chassis, thereby lowering the center of gravity of the vehicle. It is also possible to locate components away from the engine compartment, thereby evening distribution of mass over the two axles of the vehicle.

Further, because the solar air conditioning system is independent of the propulsive power plant, it can be used in conjunction with a settable thermostat to maintain the temperature of parked car from not only reaching excessive interior temperatures, but actually keep the inside temperature fairly mild even on warm and sunny days should the need arise.

It is an object of the invention to provide an air conditioning system for a vehicle power for which is not provided by the propulsive power plant of the vehicle.

Another object of the invention is to utilize energy which is free, renewable, domestically produced, devoid of pollution, and which minimizes waste heat imposed on the environment of the engine compartment.

Another object of the invention is to reduce complexity of the engine assembly.

Another object of the invention is to provide a device to keep the interior temperature of a parked vehicle within a desired comfort range even on a hot and sunny day.

A further object of the invention is to have the ability to accumulate energy when the air conditioning system is not in use.

Still another object of the invention is to eliminate the usual air conditioning system clutch.

A further object of the invention is to redistribute mass of vehicle at the discretion of the vehicle designers.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein the Drawing FIGURE is a diagrammatic side view of a motor vehicle according to several aspects of the invention.

### DETAILED DESCRIPTION

The Drawing FIGURE shows a motor vehicle 10 comprising a solar air conditioning system 12. The motor vehicle comprises a propulsive power plant such as a conventional engine (not shown), a body 14 including an upwardly exposed surface 16, a front axle 18 for supporting front wheels (only the front wheel 20 is visible), a rear axle 22 supporting rear wheels (only the rear wheel 24 is visible, and a first electrical system (not shown). The first electrical system is that system which serves both the propulsive power plant and auxiliary systems of the motor vehicle 10, for example, supplying power to a starter motor, ignition system, fuel injection system, engine and transmission management system and associated sensors, general lighting, signal lighting, brake lighting, audiovisual equipment, window, power seat, power antenna, and door lock operators, electric power steering, active suspension elements, window defogging and defrosting systems, airbags, and the like. These systems are recited only in representative capacity as illustrating electrical devices and systems which may be provided as part of the motor vehicle 10, and may or may not be present in any specific motor vehicle according to any aspect of the invention. The propulsive power plant and the first electrical system may be conventional in nature, and therefore need not be specifically shown or described in detail.

It should understood that orientational terms, such as upwardly exposed, refer to the subject matter as depicted in the Drawing FIGURE. For the purposes of collection of solar energy, upwardly and downwardly inclined and laterally exposed surfaces may also be used instead of and in addition to surfaces which are strictly speaking upwardly exposed.

The air conditioning system 12 may comprise a refrigerant compressor 26 supported at any suitable location of the body 14 of the motor vehicle 10. The refrigerant compressor 26 may be driven by an air conditioning system electric motor 28 which is directly drivably coupled to the refrigerant compressor 26 by for example a motor output shaft 30. The air conditioning system 12 will be understood to include all components necessary for successful operation, including for example heat exchangers such as a condenser and an evaporator, a blower or air handler, hoses and refrigerant conductors, fittings, refrigerant dryer, charging ports, temperature and pressure controls, and other components. The components listed herein are conventional, and therefore need not be described in detail or specifically shown.

Power to serve the electric motor 28 may be stored in an air conditioning system electrical storage battery 32 supported at any suitable location on the body 14 of the motor vehicle 10. The battery 32 may be charged by a photovoltaic cell 34 disposed at the exterior of the body 14 of the motor vehicle 10. Illustratively, the photovoltaic cell 34 may be located in whole or in part on the roof or other upwardly exposed surface 16. The photovoltaic cell 34 is shown in representative capacity only, and may comprise one photovoltaic panel or more than one.

A second electrical system, that being a dedicated air conditioning system electrical system having circuitry 36 which operably conducts electrical power obtained by the photovoltaic cell 34 to the battery 32. The circuitry 36 also operably conducts electrical power from the battery 32 to the air conditioning system electric motor 28, and has a switch 38 disposed to selectively connect and disconnect electrical power conducted from the battery 32 to the electric motor 28. As employed herein, the circuitry 36 will be understood to comprise the number of conductors, other apparatus such as switches, fuses, fuse clips, circuit breakers, connectors, and other components and connection scheme necessary to carry out the described functions. This holds true even if the circuitry 36 is discontinuous. That is, conductors and components of one part of the circuitry 36 may be separated by intervening devices such as for example the battery 32.

In one aspect of the invention, the first electrical system, that serving the propulsive power plant and many of the auxiliary functions of the motor vehicle 10 as discussed prior, may be permanently electrically isolated from the second electrical system, the latter being the electrical system which exclusively serves the solar air conditioning system. As employed herein, “permanently electrically isolated” will be taken to mean that there is no readily restorable electrical connection between the two electrical systems, such as a switch, tie breaker, or the like, such that the electrical system serving the solar air conditioning system 12 is independent of the electrical system serving electrical loads of the motor vehicle 10 other than those associated with the system 12. This feature assures that no drain on the battery 32 occurs as a result of utilizing other electrical systems of the motor vehicle 10. Therefore, power available from the battery 32 will be available to operate the refrigerant compressor 26.

In another aspect of the invention, the compressor 26 or the electric motor 28 or both are located proximate the front axle 18, while the battery 32 is located proximate the rear axle 22. The benefit of this location scheme is that overall balance of vehicular weight between the front axle 18 and the rear axle 22 is promoted. It is generally a goal of automotive designers to equalize weight over two axles. Any variation of distribution of weight of the significantly heavy components of the solar air conditioning system would be possible. For example, the relative locations of the front axle 18 and the rear axle 22 could be reversed. In another example, only one of the compressor 26 and the electric motor 28 may be located proximate either the front axle 18 or the rear axle 22. Location of a heat exchanger such as the condenser or evaporator, or of an air distribution element such as a blower, fan, or air handler enclosure may be located for purposes of weight distribution throughout the motor vehicle, or for any other purpose or purposes.

In a further aspect of the invention, the air conditioning system 12 may include a thermostat device 40 that is electronically coupled to the system 12. The thermostat device 40 may be of a well known type which is continuously adjustable, or alternatively stated, adjustable in infinite increments, within a range to close a circuit to the system 12 when ambient temperatures within the space served by the system 12 exceed a predetermined ambient temperature. Of course, the thermostat device 40 will open the circuit at ambient temperatures which are below the predetermined ambient temperature. The circuit that is so closed may be a control circuit or alternatively may be the power circuit serving for example, the electric motor 28 and a blower, fan, or air handler motor, as well as power operated control devices (not shown). The thermostat 40 can be utilized when the vehicle 10 is in a parked state. For example, on a hot and sunny day, the thermostat 40 can be set by the user to a predetermined or desired maximum temperature, such that if the cabin or interior of the vehicle 10 reaches that maximum temperature the switch 38 of the system 12 is activated and the car is cooled and maintained below the maximum temperature. This can be particularly useful when the car contains perishable items such as food or flowers, or when an occupant such as a person or a pet is deliberately left in the car or left in the car by mistake.

It should be noted that the vehicle 10 may or may not have a second air conditioning system (not shown) which is driven from the engine. An advantageous use of the system 12 is to cool the vehicle 10 without relying upon the engine and the second air conditioning, if the latter is provided. With this in mind, and according to a further aspect, the invention may comprise a method of cooling a motor vehicle which has an engine and which may or may not have a second air conditioning system, using a solar air conditioning system such as the system 12. The method may comprise the steps of:

providing a solar air conditioning comprising a refrigerant compressor, a DC electric motor drivably coupled to the refrigerant compressor, an electrical storage battery, a photovoltaic cell disposed to receive solar energy and to convert received solar energy to electrical energy, and an electrical system comprising circuitry which operably conducts electrical power obtained by the photovoltaic cell to the electrical storage battery, which operably conducts electrical power from the electrical storage battery to the DC electric motor, and has a switch disposed to selectively connect and disconnect electrical power from the electrical storage battery to the electric motor;

stopping the engine; and

operating the solar air conditioning system, using only power obtained from the photovoltaic cell and the electrical storage battery, and with the solar air conditioning system permanently electrically isolated from the electrical system of the motor vehicle.

Although the illustration depicts what is recognizable to most people as a private passenger automobile, there is no necessity that the invention be limited to automobiles. It is contemplated that the invention may find application in trucks, tractors, aircraft, boats and ships, mobile construction, farming and mining equipment, recreational vehicles, personal watercraft, gliders, wagons, railway vehicles, military vehicles, outdoor elevators and lifts, amusement rides, and the like.

It is to be understood that due to the conceptual description presented herein, components presented in the singular may be provided in the plural. Obviously, it is also feasible in some cases to provide one component in place of more than one.

It would be possible to provide a second air conditioning system (not shown) which complements and is unconnected to the solar air conditioning system 12. This may be provided for example, to provide air conditioning at night, in tunnels and other locations obstructing direct access to sunlight, and on overcast days when the amount of solar power is insufficient to operate a solar air conditioning system such as the solar air conditioning system 12.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A combination of a motor vehicle and a solar air conditioning system, comprising:
a motor vehicle having a propulsive power plant, a body including an upwardly exposed surface, a front axle disposed on the body and a rear axle disposed on the body, and a first electric system; and
a solar air conditioning system comprising:
a refrigerant compressor system comprising a refrigerant compressor supported at the body of the motor vehicle;
a solar air conditioning system electric motor drivably coupled to the refrigerant compressor;
a solar air conditioning system electrical storage battery supported at the body of the motor vehicle;
a photovoltaic cell disposed at the exterior of the body of the motor vehicle;
a second electrical system having circuitry which operably conducts electrical power obtained by the photovoltaic cell to the solar air conditioning system electrical storage battery, operably conducts electrical power from the solar air conditioning system electrical storage battery to the solar air conditioning system electric motor, and has a switch disposed to selectively connect and disconnect electrical power conducted from the solar air conditioning system electrical storage battery to the solar air conditioning system electric motor, wherein the second electrical system is electrically isolated from the first electric system.

2. The combination of claim 1, wherein the refrigerant compressor system is located proximate one of the front axle and the rear axle of the motor vehicle, and the solar air conditioning system electrical storage battery is located proximate the other one of the front axle and the rear axle of the motor vehicle.

3. The combination of claim 1, wherein the solar air conditioning electric motor is directly drivably connected to the solar air conditioning system electric motor.

4. The combination of claim 1, further comprising a thermostat device disposed to start and stop the solar air conditioning system whenever a predetermined cabin temperature is exceeded.

5. The combination of claim 4, wherein the thermostat device is adjustable to select any one predetermined cabin temperature within a range of temperatures.

6. The combination of claim 2, wherein the solar air conditioning electric motor and the refrigerant compressor are located proximate the front axle and the solar air conditioning system storage battery is located proximate the rear axle.

7. A solar air conditioner comprising:
a refrigerant compressor system comprising a refrigerant compressor, a DC electric motor drivably coupled to the refrigerant compressor, an electrical storage battery, a photovoltaic cell disposed to receive solar energy and to convert received solar energy to electrical energy, and an electrical system comprising circuitry which operably conducts electrical power obtained by the photovoltaic cell to the electrical storage battery, which operably conducts electrical power from the electrical storage battery to the DC electric motor, and has a switch disposed to selectively connect and disconnect electrical power from the electrical storage battery to the electric motor, wherein the electrical system is permanently electrically isolated from any source of electrical power other than the electrical storage battery and from any electrical system serving electrical loads other than those associated with the solar air conditioner.

8. The solar air conditioner of claim 7, wherein said switch comprises a thermostat disposed to operate the refrigerant compressor when a predetermined ambient temperature is sensed by the thermostat and to stop the refrigerant compressor when temperatures lower than the predetermined ambient temperature is sensed by the thermostat.

9. The solar air conditioner of claim 8, wherein the thermostat is continuously adjustable within a range of temperatures any one of which may be selected as the predetermined ambient temperature.

10. A method of cooling a motor vehicle having an engine and an electrical system, using a solar air conditioning system, comprising the steps of:
providing a solar air conditioning comprising a refrigerant compressor, a DC electric motor drivably coupled to the refrigerant compressor, an electrical storage battery, a photovoltaic cell disposed to receive solar energy and to convert received solar energy to electrical energy, and an electrical system comprising circuitry which operably conducts electrical power obtained by the photovoltaic cell to the electrical storage battery, which operably conducts electrical power from the electrical storage battery to the DC electric motor, and has a switch disposed to selectively connect and disconnect electrical power from the electrical storage battery to the electric motor;
stopping the engine; and
operating the solar air conditioning system, using only power obtained from the photovoltaic cell and the electrical storage battery, and with the solar air conditioning system permanently electrically isolated from the electrical system of the motor vehicle.
